(19) United States
(12) Patent Application Publication
(10) Pub. No.: US 2022/0359093 A1
(43) Pub. Date: Nov. 10, 2022

(54) PLASMA CONFINEMENT APPARATUS FOR NUCLEAR FUSION

(71) Applicant: Frank Joseph Wessel, Irvine, CA (US)

(72) Inventor: Frank Joseph Wessel, Irvine, CA (US)

(21) Appl. No.: 17/662,159

(22) Filed: May 5, 2022

Related U.S. Application Data
(60) Provisional application No. 63/184,742, filed on May 5, 2021.

(51) Int. Cl. G21B 1/05; G21B 1/17; G21B 1/15

(52) U.S. Cl. CPC G21B 1/05; G21B 1/17; G21B 1/15; G21B 1/21

(57) ABSTRACT

A plasma confinement apparatus having a vacuum tight container configured to maintain the pressure of confined plasma; an arrangement of magnet coils inside the vacuum container that define a quasi-spherical polyhedral surface; an arrangement of energetic particle beam injectors mounted inside the vacuum container and outside the magnet coils; an arrangement of energy converters configured to recover net energy produced by fusion reactions within the confined plasma; wherein, a region of quasi-spherical, low-magnetic field intensity is formed inside the arrangement of magnet coils that is configured to confine an plasma within the quasi-spherical polyhedral surface. The arrangement of magnet coils facilitates classical, magnetic confinement of plasma particles for both neutronic and aneutronic reactions, in a scalable, quasi-spherical polyhedral geometry. A quasi-spherical region of low magnetic field intensity formed within the arrangement of magnet coils allows the plasma to be high magnetic beta, thus minimizing Bremsstrahlung-based energy losses.

### CROSS-REFERENCE TO RELATED APPLICATIONS

This application claims the benefit of U.S. Provisional Application No. 63/184,742 filed May 5, 2021, which is hereby incorporated by reference, to the extent that it is not conflicting with the present application.

### BACKGROUND OF INVENTION

### 1. Field of the Invention:

The invention relates generally to nuclear fusion reactors and specifically to scalable nuclear fusion reactors configured to selectively utilize either neutronic or aneutronic fuels.

### 2. Description of the Related Art

Nuclear energy produced from fusion is likely to become a source of unlimited, clean-electric power. Current reactor concepts typically utilize fuel cycles that produce energetic neutrons (neutronic fuel cycles) within non-scalable toroidal or cylindrical reactor configurations. One consequence of this is that, due to the lack of scalability, the potential use cases for these current reactor concepts are restricted to applications requiring many GWs of power, such as large-scale power-plants. As such, smaller scale applications, such as transportation applications, that may require power on the MW scale, will not be able to utilize said current reactor configurations effectively to harness the necessary power. While neutronic fuels may be preferred for a reactor scenario, given their low input-energy requirement (low ignition temperature) and high-reaction rate, the reliance on neutronic fuel cycles, which release energetic neutrons and generate radioactive materials, results in the need to locate reactors away from population centers for safety. This further limits the applications that may use these reactors. Alternatively, aneutronic fuel cycles may produce little to no radioactive material, and thus may be fit for utilization closer to population centers but are more costly to maintain due to their naturally higher input-power requirement (high ignition temperature). Without developing alternative reactor configurations, the usage of nuclear power may be relegated to only large-scale operations using neutronic reactions.

One such alternative reactor configuration, investigated as a scalable reactor architecture for nuclear fusion reactions, is the PolyWell reactor (“Polywell”). The PolyWell reactor may utilize a plurality of circular magnetic coils arranged in a roughly spherical arrangement in order to generate a magnetic field to confine the plasma within the reactor. Said PolyWell reactor may be configured to utilize electrostatic confinement to confine ion particle and magnetic confinement to confine electron particles in order to facilitate the necessary fusion reaction. One byproduct of utilizing electrostatic confinement in the handling of ion particles is that the resultant imbalance of charged particles can only exist as a non-thermal energy distribution. This non-thermal energy distribution requires substantially increased input powers to heat and sustain the fusion reactions, thereby limiting the net-energy gain coefficient for the device to values less than unity, therefore making the production of net-energy impossible for said configuration.

Another notable issue with the configuration of the PolyWell reactor is the presence of an unbalanced magnetic flux density at the outer boundary of the reactor, which negatively influences plasma confinement. An unbalanced magnetic flux density has been found to significantly enhance charged particle losses within magnetic confinement devices, adding to other transport processes across a confinement magnetic field that arise due to microscopic and macroscopic migration of the particles' gyration centers due to collisions between species, collective behavior of the species and plasma instabilities. While further developments to the disclosed PolyWell reactor involved the implementation of different and more complex magnet configurations, similar magnetic field non-uniformities would still occur. Attempts to improve the confinement of the PolyWell reactor by increasing the number of external-circular coils did not significantly enhance said PolyWell's reactor potential, as a result of its reliance on electrostatic confinement.

FIG. 1A illustrates a six magnet coil 111a hexahedral (six sided) configuration 111, according to an aspect. FIG. 1B illustrates the simulated magnetic field 112 for the six magnet coil hexahedral configuration 111 of FIG. 1A on the X-Z plane, according to an aspect. FIG. 1C illustrates the simulated magnetic field intensity 115 along the x axis of the disclosed six magnet coil hexahedral configuration 111, according to an aspect. FIG. 2 illustrates the simulated ion particle trajectories 213 within the six magnet coil 211a hexahedral configuration 211, according to an aspect. The magnetic field simulations for the hexahedron-coil configuration of the PolyWell are illustrated in FIG. 1B, for a physical-scale size of the order of 1-meter. This approximate physical-scale size may remain consistent for each disclosed magnet coil configurations described herein. Using the same bias electrical current (“electrical current”, “electric-bias current”) 230 in all coils, the simulated magnetic field lines 112 and the contours of constant magnetic field intensity are projected onto the X-Z mid-plane, as shown in FIG. 1B. The magnetic field 112 is compressed between the edges of the magnet coils 111a. Near the center of the configuration is the region of lowest, near zero, magnetic-field intensity (“low-magnetic field intensity region”, “region of low-magnetic field intensity”) 114. As can be seen in FIG. 1C, diameter of the region of lowest, near zero, magnetic-field intensity is relatively small, as articulated by the size and shape of the trough 115a, which shows notable increases in magnetic field intensity (˜500 mTesla) as close as 200 mm from the center of the configuration.

The trajectory of specific interest here, is for a particle-orbit radius, near the magnetic boundary, that is much less than the spacing between coil centers, otherwise the particle gyro-radius would be too large and the particle might be lost. For a geometry radius of, r=0.5 m, the particle-orbit radius for an ion should be of the order of, ρ˜10⁻² m, or less. These conditions correspond approximately to a magnetic-field intensity of, |B|≡B˜5 Tesla at the coil centers, and ion-particle velocity of, vᵢ≅7×10⁶ m/s, which is an equivalent-ion energy of, Eᵢ˜500 keV, roughly 10 times higher than the energy required for fusion between Deuterium and Tritium (D—T), but roughly equal to the energy required for fusion between a proton and Boron 11 (p-B″), an aneutronic fusion reaction.

The particle trajectory simulation of FIG. 2 was run to ascertain whether, and when, a particle leaves the confinement system. A particle loss at an early time suggests the configuration is less useful, and conversely. Trajectory simulations for the (hexahedron) PolyWell are displayed in FIG. 2. For such simulations, magnetic confinement must confine the heaviest fuel particles at a sufficiently high center-of-mass energy, between particles, without loss on a timescale that is longer than that needed for a fusion reaction to occur. In the simulation, eight hydrogen-ion particles are launched at the origin, x, y, z=0 and are seen leaving the hexahedral configuration 211 in several bounce cycles and 0.1 microsecond. At this energy, the PolyWell does not provide adequate confinement, as all fuel particles are quickly lost through the centers of the coils 211a. The configuration is therefore not a promising fusion reactor candidate.

Therefore there is a need to provide a scalable reactor that is configured to effectively confine plasma particles while utilizing either neutronic or aneutronic fuel cycles.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect, a plasma confinement apparatus is provided, said plasma confinement apparatus comprising: a vacuum tight container configured to maintain the pressure of confined plasma; a rhombicosidodecahedron arrangement of magnet coils inside the vacuum tight container that defines a quasi-spherical polyhedral surface; an arrangement of several neutralized, intense ion beam injectors mounted inside the vacuum tight container and outside the rhombicosidodecahedron arrangement of magnet coils; an arrangement of direct energy converters mounted inside the vacuum tight container and outside the rhombicosidodecahedron arrangement of magnet coils, said direct energy converters being configured to recover net energy produced by fusion reactions within the confined plasma; wherein, a low-magnetic field intensity region is formed inside the rhombicosidodecahedron arrangement of magnet coils, said low-magnetic field intensity region being configured to confine plasma within the quasi-spherical polyhedral surface. Thus, an advantage is that the disclosed reactor is scalable, as its quasi-spherical geometry allows for the formation of a suitably strong magnetic field with a central, low magnetic-field intensity region at both smaller and larger reactors sizes, while maintaining classical confinement of plasma particles and preventing their leakage out of the reactor. Another advantage is that, by maintaining a low or near zero intensity magnetic field region within the center of the arrangement of magnet coils, the reactor is configured to confine the plasma in high magnetic beta, thus reducing energy losses to Bremsstrahlung-radiation. Another advantage is that the disclosed reactor is configured to utilize either neutronic or aneutronic fuel cycles through suitably adjusting the magnetic field intensity, as well as the operating parameters of the neutralized, intense ion beam injectors and the direct energy converters.

In another aspect, a plasma confinement apparatus is provided, the plasma confinement apparatus comprising: an arrangement of magnet coils that define a quasi-spherical polyhedral surface; an arrangement of energetic particle beam injectors mounted outside the arrangement of magnet coils; an arrangement of energy converters mounted outside the arrangement of magnet coils, said energy converters being configured to recover net energy produced by fusion reactions between confined plasma particles; wherein, a low-magnetic field intensity region is formed inside the arrangement of magnet coils, said low-magnetic field intensity region being configured to confine plasma within the quasi-spherical polyhedral surface. Again, an advantage is that the disclosed reactor is scalable, as its quasi-spherical geometry allows for the formation of a suitably strong magnetic field with a central, low magnetic-field intensity region at both smaller and larger reactors sizes, while maintaining classical confinement of plasma particles and preventing their leakage out of the reactor. Another advantage is that, by maintaining a low or near zero intensity magnetic field region within the center of the arrangement of magnet coils, the reactor is configured confine the plasma in high magnetic beta, thus reducing energy losses to Bremsstrahlung-radiation. Another advantage is that the disclosed reactor is configured to utilize either neutronic or aneutronic fuel cycles through suitably adjusting the magnetic field intensity, as well as the operating parameters and types of energetic particle beam injectors and energy converters utilized.

In another aspect, a plasma confinement apparatus is provided, the plasma confinement apparatus comprising: an arrangement of magnet coils that define a quasi-spherical polyhedral surface, wherein adjacent magnet coils within the arrangement of magnet coils are alternately biased; wherein a low-magnetic field intensity region is formed inside the arrangement of magnet coils, said low-magnetic field intensity region being configured to confine plasma within the quasi-spherical polyhedral surface. Again, an advantage is that the disclosed reactor is scalable, as its quasi-spherical geometry allows for the formation of a suitably strong magnetic field with a central, low magnetic-field intensity region at both smaller and larger reactors sizes, while maintaining classical confinement of plasma particles and preventing their leakage out of the reactor. Another advantage is that, by maintaining a low or near zero intensity magnetic field region within the center of the arrangement of magnet coils, the reactor is configured confine the plasma in high magnetic beta, thus reducing energy losses to Bremsstrahlung-radiation. Another advantage is that the disclosed reactor is configured to utilize either neutronic or aneutronic fuel cycles through suitably adjusting the magnetic field intensity, as well as the implementing selected types of energetic particle beam injectors and energy converters.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1A illustrates a six magnet coil hexahedral configuration, according to an aspect.

FIG. 1B illustrates the simulated magnetic field generated for the six magnet coil hexahedral configuration of FIG. 1A on the X-Z plane, according to an aspect.

FIG. 1C illustrates the simulated magnetic field intensity along the x axis of the disclosed six magnet coil hexahedral configuration, according to an aspect.

FIG. 2 illustrates the simulated ion particle trajectories within the six magnet coil hexahedral configuration, according to an aspect.

FIG. 3 illustrates the sectioned perspective view of the herein disclosed fusion reactor, according to an aspect.

FIG. 4A illustrates the perspective view of a quasi-spherical rhombicosidodecahedron arrangement of magnetic coils, according to an aspect.

FIG. 4B illustrates the polygon coil network of the quasi-spherical rhombicosidodecahedron arrangement of magnetic coils, according to an aspect.

FIG. 4C illustrates the magnetic field simulations generated for the disclosed quasi-spherical rhombicosidodecahedron arrangement of magnetic coils of FIG. 4A on the X-Z plane, according to an aspect.

FIG. 4D illustrates the simulated magnetic field intensity along the x axis of the disclosed quasi-spherical rhombicosidodecahedron arrangement of magnetic coils, according to an aspect.

FIG. 4E illustrates the simulated particle trajectories within the disclosed quasi-spherical rhombicosidodecahedron arrangement of magnet coils, according to an aspect.

FIG. 5A illustrates the perspective view of an arrangement of triangular magnetic coils arranged in a quasi-spherical polyhedron configuration, according to an aspect.

FIG. 5B illustrates the polygon coil network of the disclosed arrangement of triangular magnetic coils arranged in a quasi-spherical polyhedron configuration of FIG. 5A, according to an aspect.

FIG. 5C illustrates magnetic field line simulations generated for the disclosed arrangement of triangular magnetic coils arranged in a quasi-spherical polyhedron configuration

of FIG. 5A, according to an aspect.

FIG. 5D illustrates simulated particle trajectories for the disclosed arrangement of triangular magnetic coils arranged in a quasi-spherical polyhedron configuration, according to an aspect.

FIG. 6A illustrates plasma propagation into a transverse magnetic B field, according to an aspect.

FIG. 6B-6D illustrates neutralized, intense ion beams of various energy and polarity conditions propagating through the transverse magnetic B field, according to an aspect.

FIG. 6E illustrates the current of a repetitively pulsed neutralized ion beam over time, according to an aspect.

FIG. 7 illustrates a simplified power balance diagram for the disclosed reactor, according to an aspect

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by one of ordinary skills in the art.

For the following description, it can be assumed that most correspondingly labeled elements across the figures (e.g., 302 and 402, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

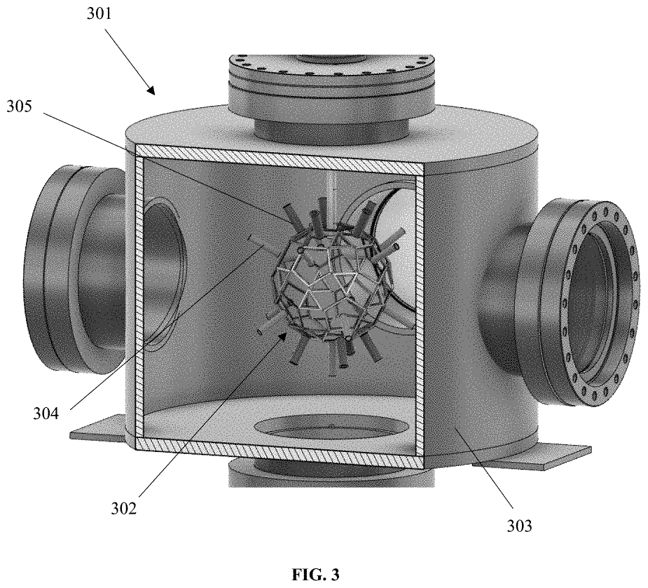

FIG. 3 illustrates the sectioned perspective view of the herein disclosed fusion reactor 301, according to an aspect. The disclosed fusion reactor (“reactor”, “plasma confinement apparatus”, “confinement apparatus”) 301 may be comprised of a vacuum tight container (“vacuum container”) 303, an arrangement of magnet coils (“magnetic coils”, “coils”) 302 that define a quasi-spherical polyhedral surface enclosed within the vacuum tight container 303, an arrangement of energetic particle beam injectors 304 mounted inside the vacuum tight container 303 and outside of the arrangement of magnet coils 302 and an arrangement of energy converters 305 also inside the vacuum tight container 303 and outside of the arrangement of magnet coils 302, wherein the energy converters are configured to recover net energy produced by aneutronic fusion reactions. Where the fusion process is primarily neutronic, the reactor may also be configured for energy recovery using concepts broadly developed in the fusion community, for example using a neutron absorbing liquid blanket surrounding the fusion reaction and which is used to subsequently convert the energy in a thermal process. Both energy recovery concepts may also be configured for fusion processes that produce a combination of charged particles and neutrons. A quasi-spherical region of low-magnetic field intensity may be generated inside the arrangement of magnetic coils 302 that confines an energetic, hot plasma (“plasma”, “plasma particles”) during reactor operation. The functions and specifications of these elements will be described in greater detail hereinbelow.

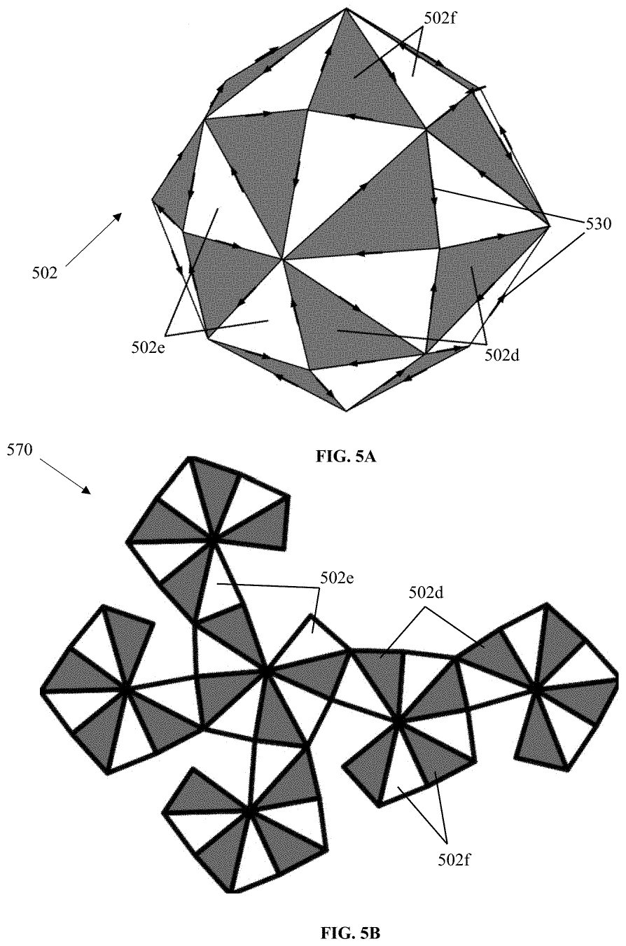

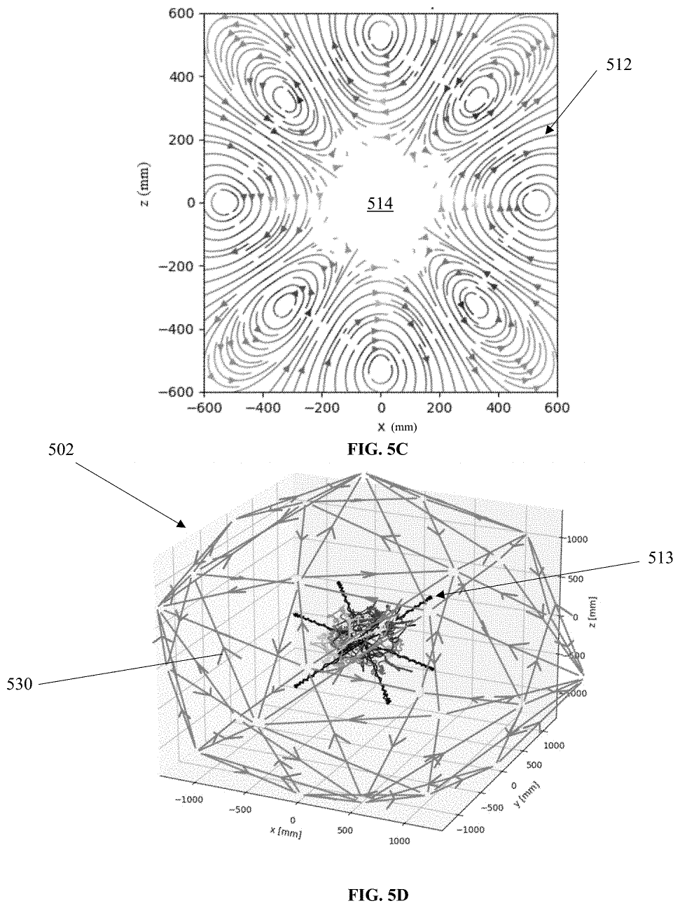

The term “quasi-spherical” within the context of this application should be understood to be defined by a set of points for which the quadratic form for the space applied to the displacement vector from a center point is a constant value, whereas a “polyhedron” would be a three-dimensional structure composed of flat polygonal faces, straight edges and sharp corners or vertices. As such, the vertices at the corners of polygonal faces of a “quasi-spherical polyhedron” would each be approximately the same distance from a center point of said quasi-spherical polyhedron. It should be understood that both the region of low-magnetic field intensity inside the arrangement of magnetic coils, such as low-magnetic field intensity region 514 of FIG. 5C, and the surface that is defined by arrangement of magnet coils 302 may both be quasi-spherical in shape. In instances in which the arrangement of magnetic coils 302 is quasi-spherical, it may be expected that the resultant region of low-magnetic field intensity is also quasi-spherical, as a result of said region's shape and size being dependent of that of the arrangement of magnet coils 302.

As described, a vacuum tight container 303 may surround the other disclosed elements of the fusion reactor 301. An essential function of this vacuum tight container 303 is to maintain the base pressure of the vacuum chamber with no plasma to be at least a 10⁵ times smaller than when the plasma is confined within the reactor. This an essential aspect of maintaining a clean, uncontaminated, high beta (“magnetic beta” “β”) value for the contained plasma, which is particularly crucial for maintaining aneutronic reactions. It may be assumed that the vacuum tight container 303 will be scaled properly to suitably achieve this maintenance of plasma pressure, regardless of reactor 301 scale.

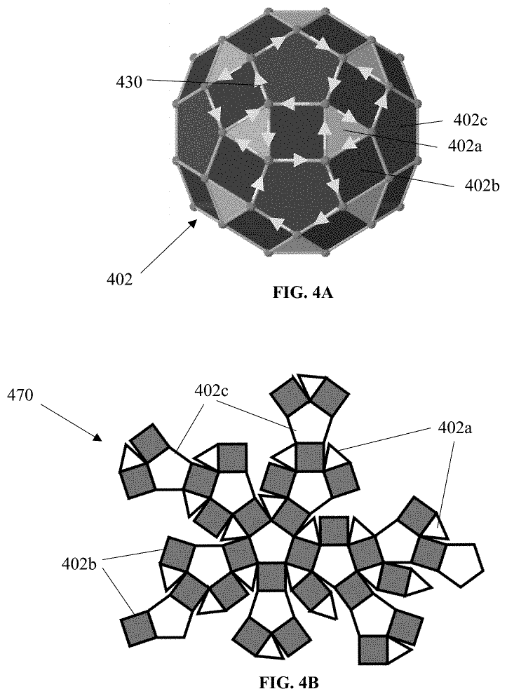

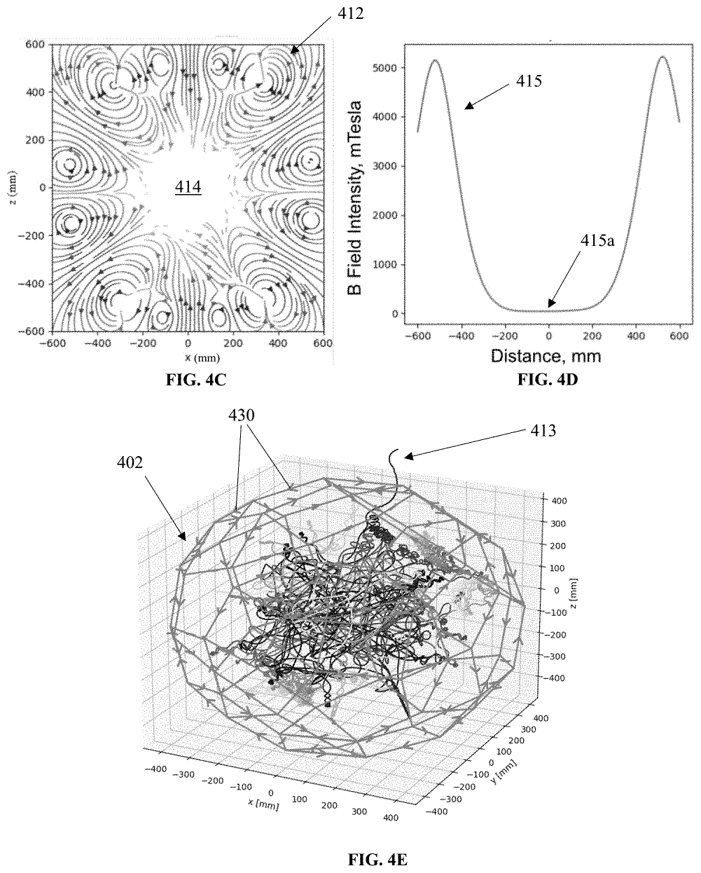

The arrangement of magnetic coils 302 enclosed within the vacuum tight container 303 may be used to establish a quasi-spherical, low-magnetic field intensity region, such as low-magnetic field intensity region 514 of FIG. 5, within the arrangement of magnetic coils to suitably confine the plasma of the reactor 301 during operation. The disclosed reactor 301 utilizes individually-biased magnet coils 302, positioned on the outer surfaces of a polyhedron, to produce a boundary-magnetic field of sufficient intensity and direction to confine an ensemble of highly-energetic charged particles comprising a fusion-plasma core. As disclosed above, the arrangement of magnet coils 302 may define any quasi-spherical, polyhedral surface, such as an octahedron, icosahedron, or as disclosed herein, a disdyakis dodecahedron, as seen in FIG. 5A, or a rhombicosidodecahedron, as seen in FIG. 4A. The shape of each magnetic coil may be uniform, as seen in FIG. 5A, wherein each magnetic coil 502d, 502e is triangular. Alternatively, the magnetic coils utilized within the arrangement of magnetic coils 302 may be provided in various shapes, such as triangles 402a, 402a, squares 402b, pentagons 402c, as depicted in FIGS. 4A-4E, and potentially other polygon shapes of higher order, such as hexagons, heptagons, octagons, etc. As long as each magnetic coil in the arrangement of magnetic coils 302 is arranged in such a way that the physical space between adjacent magnetic coils is minimized, magnetic coils of any suitable shape or combination of shapes may be utilized to define the aforementioned quasi-spherical polyhedral surface. The configuration of the disclosed arrangements of magnet coils 302 will be described in greater detail hereinbelow.

It should be understood that the term “adjacent” with regards to magnet coils (e.g., adjacent magnet coils) only includes magnet coils that share edges and not magnet coils that simply share a singular corner. For example, in FIG. 4A, each pentagonal magnetic coil 402c is adjacent to each of the corresponding five square magnet coils 402b that it shares an edge with. In contrast, each pentagonal magnet coil 402c is not adjacent to any triangular magnet coil 402a, as any triangular magnet coils will only share a corner, at most, with a corresponding pentagonal magnet coil 402c. Each square magnetic coil 402b is adjacent to two triangular magnet coils 402a and two pentagonal magnet coils 402c. In FIG. 5A, each first magnetic coil 502d is adjacent to three different second magnetic coils 502e, each second magnetic coil sharing a singular corresponding edge with the first magnetic coil 502d. In an alternative configuration, any pair of magnetic coils may be described as being adjacent if they share an edge. While the provided examples may only include the specific embodiments of the arrangements of magnetic coils of FIGS. 4A-4E and FIGS. 5A-5D, other configurations are also possible. Any suitable adjacent polygonal magnet coils having alternating magnetic polarities may be utilized to balance the magnetic flux density at the quasi-spherical polyhedral surface.

It should be understood that while each magnet coil of an arrangement of magnetic coils 302 may be provided as a separate, distinct, structural element prior to assembly of the arrangement of magnet coils, certain magnet coils may exist or be provided as “virtual magnet coils” that are formed as a result or byproduct of the arrangement of other magnet coils over the quasi-spherical surface. For example, as seen in FIG. 4 and emphasized by FIG. 3, each triangular magnet coil 402a and pentagonal magnet coil 402c may exist as separate structural elements which may be organized into an arrangement of magnet coils 402. By arranging the physical structures of these triangular 402a and the pentagonal 402c magnet coils over the quasi spherical surface, virtual magnet coils having a square shape may be formed in the gaps between the triangular 402a and the pentagonal magnet coils 402c on the quasi-spherical surface. It should be understood that these virtual square magnet coils may be formed by the edges of corresponding triangular 402a and the pentagonal 402c magnet coils and may have a magnetic field polarity based on the current flowing through the edges of the magnet coils that form it. Virtual magnet coils may also be found in other arrangement of magnet coils. It should be understood that both virtual magnet coils (magnet coils formed by surrounding, structural magnet coils) and structural magnet coils (coils that may exist as a standalone structure) may both be referred to as magnet coils for simplicity.

In alternative arrangements of magnet coils, such as the arrangement of magnet coils 502 of FIG. 5A, each first magnet coil 502d may exist as a triangular magnet coil regardless of presence of other magnet coils, (e.g., prior to the assembly of the arrangement of magnet coils 502) whereas each second magnet coil 502e may be formed in the spaces between the first magnetic coils, wherein each second magnet coil 502e is a virtual magnet coil. Alternatively, each first 502d and second magnet coil 502e may be a standalone, structural, triangular magnet coil regardless of its association with adjacent magnet coils. The structural magnet coils of said embodiment may all be “actively magnetically biased”, which may allow for modification of the magnetic field over a small, localized region, which may accommodate access for applicable elements, including energetic particle beam injectors and energy converters.

The coils of the arrangement of magnet coils 302 are biased by an external power source and the magnetic field is directed toward the polyhedron's center, where by symmetry, a magnetic cavity of near zero field intensity is produced where the fusion fuel (e.g., plasma) is burned. Electric current, such as electrical current 530 of FIG. 5D, may flow along the polyhedron's edges where it is shared by adjacent coils because adjacent coils may be linked magnetically to each other near the polyhedron's outer surface. As seen in the simulated magnetic fields 412, 512 of FIGS. 4C and 5C, respectively, the magnetic-field has an outward curvature and radially increasing intensity, therefore, the fusion-plasma core is stable and characterized by an average plasma energy density near the center that is much greater than the magnetic-energy density. Thus, the core plasma is inherently high magnetic beta, defined as, β≡2μ₀nkT/B²>1, with n the plasma density per unit volume, k the Boltzman constant, T the plasma temperature, and B the magnetic-field intensity.

As will be discussed herein, high magnetic β minimizes the synchrotron radiation produced by magnetized, energetic-plasma particles, reducing power loss and increasing the overall power efficiency of the reactor 301. Maintaining high magnetic β is particularly relevant for aneutronic reactions, as these generally larger fuel particles are particularly susceptible to energy losses from synchrotron radiation due to their higher atomic number and higher ionization states. These energetic-charged particles are magnetically confined, following trajectories throughout the quasi-spherical volume formed within the quasi-spherical polyhedral surface, allowing them to continuously interact with, scatter off, and heat the plasma-fuel particles confined in the core.

As described hereinabove, for certain arrangements of magnetic coils, such as the arrangement of magnet coils 502 of FIG. 5A-5D, the electric-bias current supplied to each coil may be supplied along the edges of the quasi-spherical polyhedron and be shared between adjacent coils 502f In such a configuration, each first magnet coil 502d may be a structural magnet coil and the electric-bias current may be supplied along the edges of each first magnet coil 502d, whereas each second magnet coil 502e may be virtual, and thus share the electric bias current of each adjacent first magnet coils 502d. Similarly, for the arrangement of magnetic coils 402 of FIG. 4A-4E, the electric-bias current may need only be applied directly to the boundaries of the triangular 402a and pentagonal coils 402c, that is, the square coils 402b are indirectly biased, sharing the electric current at their boundaries with corresponding adjacent magnet coils. In such a configuration, the triangular magnet coils 402a and pentagonal magnet coils 402c may exist as structural magnet coils, whereas the indirectly biased square magnet coils 402b may exist as virtual magnet coils.

Note that an equivalent magnetic field shape and distribution will be produced when the electric bias current is supplied only to the boundaries of the virtual coils, and not the structural coils, as above. As a result, each of these disclosed reactors are therefore defined by a multipole-magnetic field of much higher order than previously suggested for nuclear fusion. Moreover, the confined particle distribution in the disclosed reactors may be expected to be in thermal equilibrium, as the particle confinement is primarily magnetic in a high-intensity magnetic field, and not based on the electrostatic confinement of charged particles in a potential well, sustained by the injection of beams of one charged particle species. In aggregate, the number of confined particles for both species, electrons and ions, are roughly equivalent, producing a confined plasma that has a total net electric charge that is approximately balanced and effectively neutral. At the temperature and density conditions needed to sustain a fusion reaction, a net-charge imbalance may still exist due to an imbalance in the transport losses of the confined plasma species.

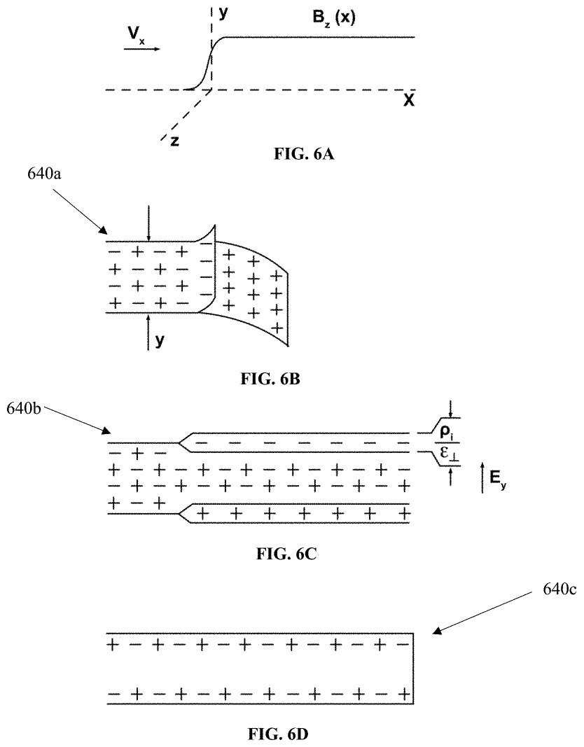

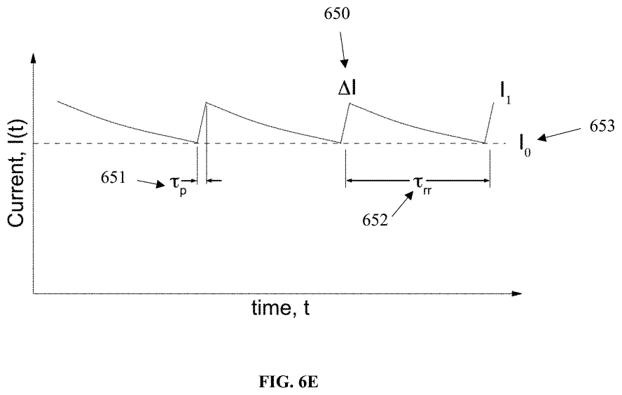

The energetic particle beam injectors 304 represented by the lighter gray tubes may be utilized to both provide heating to the plasma of the reactor, as well as to resupply the reactor fuel components as they are burned up in the contained fusion reaction. The type of particle beam injectors utilized in the herein disclosed reactor 301 may differ from those utilized in typical neutronic reactors, as the herein disclosed fusion reactor 301 may be configured to power an aneutronic fuel cycle having a greater ignition temperature, and thus may required a higher energy particle beam to maintain said aneutronic fuel. For neutronic fusion fuels, neutral-beam injectors (“NBIs”) are widely used as energetic particle beam injectors 304 to produce atomic particle beams. However, an aneutronic-fusion reaction typically requires a much higher particle energy and more heat input than said NBI systems can efficiently provide, requiring particle energies in the range of, Tᵢ≅500-3,500 keV, depending on the aneutronic fuel cycle. Therefore, the disclosed fusion reactor may also use a charge and current neutralized, intense ion beam (NIB). NIB systems (“NIB injectors”) may be repetitively pulsed at several hundred Hz, with pulse durations, τₚᵤₗₛₑ, on the μs scale. NIB based systems may be less highly developed when compared to their NBI counterparts, but their technical capabilities are well established. The potential mechanisms through which this NIB may penetrate the magnetic field of the reactor to heat and fuel the plasma reaction will be discussed in FIG. 6A-6D hereinbelow. Furthermore, these NIB high-energy-particle injectors, as well as radio-frequency wave injectors, or both, may be used to heat the plasma to fusion temperatures. External access to the plasma is required for these options and is enabled by the use of the surface-grid arrangement of high-open area polygon coils, where these heating sources may be placed. When utilizing the described NIB injectors, additional high-voltage pulse electronics may be required for each injector, that determines the extraction voltage, i.e., ion energy, pulse-duration, and integrated energy injected per pulse.

Alternatively, linear accelerators may be utilized produce a broad range of ion species at the desired energy. These accelerators produce a much smaller current-density, and may also be useful to inject beams into cusp magnetic fields to alter the confinement timescales for the fusion plasma. It should be understood that other alternative energetic particle beams and heating mechanisms may be utilized as allowed by the application and specifications of the accompanying reactor.

As mentioned above, the arrangement of energy converters 305, represented by the darker gray tubes, may be configured to recover net energy produced by fusion reactions between confined plasma particles within the reactor 301. The exact specification of these energy converters may be dictated by the type of fusion reaction occurring in the reactor. For example, when the disclosed fusion reactor 301 is utilizing an aneutronic fuel cycles, energy converters 305 such as high efficiency, direct-energy converters (“DECs”) may be required to capture and recover the energy of the charged particle fusion-product stream. Additionally, photonic converters configured to recover the Bremsstrahlung photon energy generated from the fusion reaction may also be provided as part of the energy converters 305, or as a differently configured standalone system (not shown). In the herein disclosed embodiments, as a result of the high transparency of the disclosed coil structure, it would be possible to mount the photonic converters either inside, or outside, the arrangement of magnet coils 302. DECs are essentially inverse particle accelerators, and several DEC concepts are envisioned, using electrostatic and wave deceleration, with overall cycle conversion efficiency estimates of, η_{c}˜0.9. A key consideration for DECs relates to the focusing and capture of the energetic fusion products broadly emitted into 4π steradians as a wide velocity-space distribution. In a high-magnetic beta and high Tesla B-field, the charged-fusion products are preferentially lost along the field, into the magnetic cusps aligned with the disclosed energy converters 305, facilitating their efficient capture and recovery. The type, specification and quantity of energy converters 305 utilized will be dictated by the fuel cycle utilized by the reactor 301, the specifications of the arrangement of the magnetic coils 302, the local magnetic field intensity, amongst other operational factors. It should be understood that the individual energy converters 305, such as the described DECs, will require additional electronics (not shown) to adjust their power outputs, for example, to adjust and match the phasing and voltage gradients needed to extract energy.

In general, the energy gain factor for a fusion reaction is given as, Q=Eₒᵤₜ/(E_{heating}+E_{radiation}), where Eₒᵤₜ is the reaction's output-nuclear energy, E_{heating} is the energy needed to heat the fuel, and E_{radiation} is the radiant energy produced. For fusion the heat energy may be provided using particle beams comprised of energetic ions, electromagnetic waves, a combination of the two methods, or other methods. When calculating the energy gain from the above equation, the E_{heating} term is usually neglected, since the residual-beam energy imparted to the fusion particles is conserved in the reaction products as excess energy above that derived from the fusion reaction itself, which is assumed to be efficiently recovered. Aneutronic fuels produce higher levels of bremsstrahlung-radiation power, due to the higher atomic number for aneutronic fuels and, therefore, the E_{radiation} term cannot be recovered efficiently, thereby reducing the Q. Calculation of the gain factors for the several known fusion fuels, including proton-boron fusion (p-B¹¹), deuterium-helium fusion (D—He³), deuterium-deuterium fusion (D—D), and deuterium-tritium fusion (D—T), provides the approximate ratios: Q_{p-B}¹¹≅3.5, Q_{D—He}³≅5, Q_{D—D}≅8, and Q_{D—T}≅25.

Broadband radiation emitted by the aneutronic plasma is in the range, E≅0.1-1 MeV, and several photonic converter solutions are under development elsewhere. Present approaches to energy conversion use multi-layer materials, achieving a conversion efficiency, ηₚ, of less than 0.1. Theoretical predictions are for an efficiency at least a factor of two times higher, and potentially as high as, ηₚ˜0.30. Thus, further research and development is necessary, since the output radiation from most aneutronic fuels exceeds 10% of the nuclear power.

It should be understood that the details and specification of each of the hereinabove listed elements may be carefully selected based on the specific fuel cycle used as well as the desired scale and thus output power of the reactor. As will be discussed in greater detail herein, the output power for such a design may be uniquely scalable, increasing with the radius of the fuel core as, such that the output power is proportional the cubed radius (r³) of the fuel core, and thus the radius of the quasi-spherical surface formed by the arrangement of magnet coils 302. The scalability and versatility of the disclosed reactor 301 will be disclosed in greater detail hereinbelow. It should also be understood that each component of the disclosed plasma confinement apparatus/reactor 301 including the arrangement of magnet coils 302, vacuum tight container 303, energetic particle beam injectors 304, energy collectors 305 and any other elements, may be composed of known materials in the field for their respective elements.

FIG. 4A illustrates the perspective view of a quasi-spherical rhombicosidodecahedron arrangement of magnetic coils 402, according to an aspect. FIG. 4B illustrates the polygon coil network 470 of the quasi-spherical rhombicosidodecahedron arrangement of magnetic coils 402, according to an aspect. FIG. 4C illustrates the magnetic field 412 simulations generated by the disclosed quasi-spherical rhombicosidodecahedron arrangement of magnetic coils 402 of FIG. 4A on the X-Z plane, according to an aspect. FIG. 4D illustrates the simulated magnetic field intensity 415 along the x axis of the disclosed quasi-spherical rhombicosidodecahedron arrangement of magnetic coils 402, according to an aspect. FIG. 4E illustrates the simulated particle trajectories 413 within the disclosed quasi-spherical rhombicosidodecahedron arrangement of magnet coils 402, according to an aspect.

Similarly to the arrangement of magnetic coils depicted in FIG. 3, the herein disclosed arrangement of magnetic coils 402 may also be comprised of a plurality of differently shaped magnetic coils 402a, 402b, 402c arranged into a polyhedral architecture. The arrangement of magnetic coils 402 may be comprised of a plurality of triangular magnet coils 402a, square magnet coils 402b and pentagonal magnet coils 402c arranged over a quasi-spherical polyhedral surface wherein each magnetic coil is arranged to minimize the physical gaps between itself and its neighboring magnet coils. The significance of gap minimization will be explored in greater detail hereinbelow. In the disclosed embodiment of FIGS. 4A-4E, the disclosed rhombicosidodecahedron arrangement of magnetic coils may be comprised of 20 triangular coils 402a, 30 quadrilateral (square) coils 402b, and 12 pentagonal coils 402c, for a total of 62 magnet coils. It should be understood that the scope of the present invention should not be limited exclusively to the specific embodiments depicted and described in FIGS. 4A-5D. Instead, the essence of the present invention is extensible to a larger, or smaller, construct, where the number of polygon coils is increased, or decreased, and the individual coil shapes altered to include, for example: squares, pentagons, hexagons, etc., and combinations thereof, in order to achieve a full coverage of a quasi-spherical polyhedral surface where the magnetic field intensity at the coil centers is approximately equal and uniformly distributed across the inner surface of the polyhedron. This is possible because the sum of the triangle and pentagon coil areas is nearly equal to that for the square coils, i.e., Σ₂₀Aₜ+Σ₁₂Aₚ=Σ₃₀Aₛ, wherein Aₜ is the area of a triangular coil 402a, Aₚ is the area of a pentagonal coil 402c and Aₛ is the area of a square coil 402b. The polygon coil network 470 of FIG. 4B may provide a flattened perspective of the arrangement of magnet coils 402 in which all of the magnet coils 402a, 402b, 402c are visible. It should be understood that not all of the magnet coils shown within the disclosed polygon coil network 470 may exist as structural magnet coils, and that some of the magnet coils 402a, 402b, 402c illustrated in the polygon coil network 470 may exist as virtual coils, as will be discussed in greater detail hereinbelow.

The direction of the electrical current 430 flowing through the edges each of the magnet coils 402a, 402b, 402c as indicated by the directional arrow of FIGS. 4A-4C, results in the polarities of adjacent magnetic coils having “alternately biased” magnetic polarities (e.g., the polarity of adjacent magnet coils, such as the square magnet coils 402b and the pentagonal magnet coils 402c, are opposite). To be more specific, the magnetic-field polarity is the same for all triangular 402a and pentagonal coils 402c, while all square coils 402b have the opposite polarity. The magnetic-field intensity at the centers of all coils is taken for the present discussion and examples disclosed herein, to be approximately equal, at |B|≅5 T. The alternating magnetic-field polarity at the quasi-spherical polyhedral surface that minimizes the physical gaps between adjacent coils allows each magnet coil's individual-magnetic field to return through the adjacent coils. Based on the direction of the electrical current 430, the magnetic field 412 traveling through each triangular 402a and pentagonal coils 402c may point toward the center of the arrangement of magnet coils 402, whereas the magnetic field 412 traveling through each square coil 402b may point away from the center of the arrangement of magnet coils 402.

The herein disclosed plasma confinement apparatus is configured to provide a scalable infrastructure that provides magnetic confinement capabilities that enable the utilization and confinement of the higher energy particles needed for aneutronic fusion. As can be seen in FIG. 4C, the quasi-spherical arrangement of magnetic coils 402 results in the magnetic field 412 forming a region of low-magnetic field intensity 414 around the core plasma of the disclosed plasma confinement apparatus. The confinement efficacy of this disclosed reactor configuration is demonstrated is FIG. 4E, wherein particle trajectory simulations for the quasi-spherical polyhedron are displayed. In the particle trajectory simulations of FIG. 4E and FIG. 5D, the darker portions of the particle trajectory 413, 513 correspond to earlier trajectory times and the lighter portions of the particle trajectory correspond to later trajectory times. In said simulation, eight independent eight hydrogen-ion particles are launched at zero time from the center of the polyhedron: one in each opposite direction along each coordinate axis, ±x, ±y, ±z and two more at ±45° toward the corners. The operating conditions for the particles in this simulation are the same as those for the particle simulation for the hexahedral coil configuration 211 of FIG. 2, with a magnetic-field intensity of, |B|≡B˜5 Tesla, and ion-particle velocity of vᵢ≅7×10⁶ m/s. As can be seen by the confined particle trajectories, said rhombicosidodecahedron arrangement of magnetic coils 402 provides excellent particle confinement nominally equivalent conditions, as evidenced by the ion particle remaining confined within the observed timespan. As such, this concept is suitable for both neutronic and aneutronic fusion reactions, where it is understood that aneutronic fusion reactions require an appropriate increase in the magnetic field intensity needed to magnetically confine the particles and an increased in the particle energies needed to exceed their respective fusion temperature thresholds.

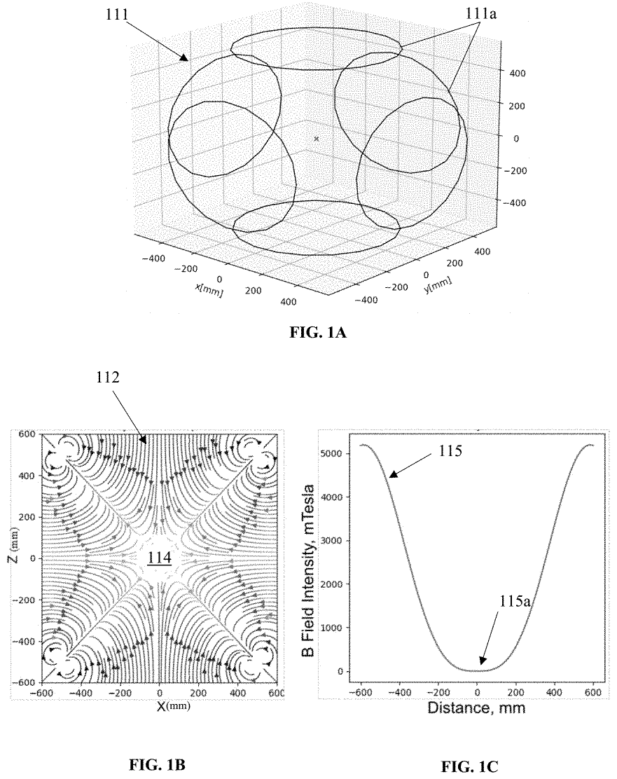

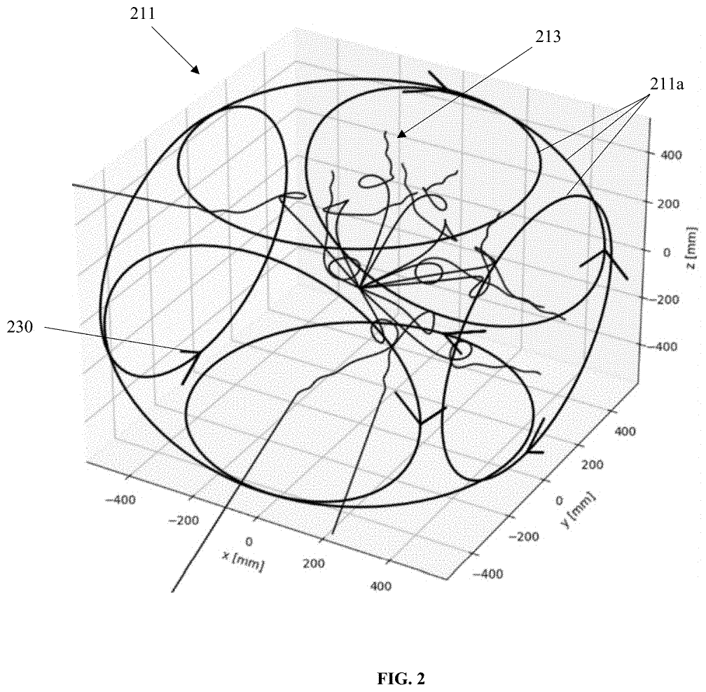

As seen by the size of the trough 415a within the magnetic field intensity 415 along the x axis, as depicted in FIG. 4C, the low-magnetic field intensity region 414 formed within the disclosed rhombicosidodecahedron arrangement of magnetic coils 402 has a greater diameter and steeper profile than the low-magnetic field intensity region 114 formed within the disclosed hexahedral arrangement of magnetic coils of FIG. 1C. The magnetic field intensity 415 remains roughly minimized at distances up to 200 mm from the center (0 mm) of the quasi-sphere, as indicated by the size and shape of the trough 415a, reaching a field strength of 500 mTesla at roughly 300 mm from the center. This larger size of the low-magnetic field intensity region 414 of the disclosed rhombicosidodecahedron arrangement of magnet coils 402 allows for maintenance of a larger low-beta plasma region within said arrangement of magnet coils 402 than that of the prior disclosed hexahedral configuration 111 of FIG. 1A, thus minimizing potential energy losses from Bremsstrahlung radiation. Moreover, it can be seen from a comparison of curves in FIGS. 1C and 4D that the polyhedral geometry constructed using a larger number of individual coils is more effective in producing a larger volume in the central region of low, to zero, magnetic field intensity than for the hexahedral configuration.

FIG. 5A illustrates the perspective view of an arrangement of triangular magnetic coils arranged in a quasi-spherical polyhedron configuration, according to an aspect. FIG. 5B illustrates the polygon coil network 570 of the disclosed arrangement of triangular magnetic coils 502d, 502e arranged in a quasi-spherical polyhedron configuration of FIG. 5A, according to an aspect. FIG. 5C illustrates magnetic field line simulations generated for the disclosed arrangement of triangular magnetic coils 502 arranged in a quasi-spherical polyhedron configuration of FIG. 5A, according to an aspect. FIG. 5D illustrates simulated particle trajectories 513 for the disclosed arrangement of triangular magnetic coils 502 arranged in a quasi-spherical polyhedron configuration, according to an aspect. As can be seen in FIG. 5A, this particular embodiment of the arrangement of magnetic coils 502 may be comprised of 48 triangular magnetic coils 502d, 502e arranged around a disdyakis dodecahedron (12-hedron). Similarly to the polygon coil network 470 of FIG. 4B, the polygon coil network 570 of FIG. 5B may provide a flattened perspective of the herein disclosed arrangement of magnet coils 502 in which all of the coils are visible. As described for the polygon coil network 470 of FIG. 4B, not all of the magnet coils shown within the disclosed polygon coil network 570 of FIG. 5B may exist as structural magnet coils, and some of the magnet coils 502d, 502e illustrated in the polygon coil network 570 may exist as virtual coils, as discussed hereinabove.

While the magnetic coils 502d, 502e depicted in FIG. 5A may be triangular, as described hereinabove, any shape(s) of magnetic coil may be utilized, including but not limited to triangles, squares, pentagons, hexagons, octagons, N-gons (shapes having “N” sides) etc. and combinations thereof, as long as complete coverage of the quasi-spherical polyhedral surface is achieved with minimized physical space between adjacent magnet coils 502f. Furthermore, the size of the individual magnetic coils 502d, 502e and number of magnetic coils used may be modified to establish the required size scale to achieve a certain output power for the associated reactor. The herein disclosed plasma confinement apparatus may rely solely on magnetic confinement for the confinement of both electron particles and ion particles. For plasma confinement apparatuses utilizing the disclosed arrangements of magnet coils 402, 502 disclosed in FIG. 4A-4E and 5A-5D, respectively, relying solely on magnetic confinement for the confinement of both electron particles and ion particle may provide superior confinement when compared to alternative configurations that may utilize electrostatic confinement. This confinement method is of particular relevance for the more challenging aneutronic fuels, as will be discussed in greater detail herein.

In order to suitably provide a plasma confinement apparatus that is scalable and that may maintain core plasma that is inherently high beta, it may be necessary to arrange the plurality of magnetic coils used to form the polyhedral surface in a particular configuration with regards to their adjacent, surrounding magnetic coils. As can be seen in FIG. 5A the magnetic coils of the plasma confinement apparatus may be arranged such that each first, gray-shaded magnetic coil 502d having a first magnetic field polarity is surrounded by adjacent, second, white-colored magnetic coils 502e that have a second, opposite magnetic field polarity. This configuration of magnetic coils may be referred to as being “alternately biased” (“alternately magnetically biased”), wherein the adjacent magnetic coils 502d, 502e have opposite magnetic polarities, as a result of sharing the electrical current 530 traveling about their edges. As can be seen from the directional current flow 530 traveling through the edges of each magnet coil, the magnetic field traveling through each first magnet coils 502d may point inward toward the center of the quasi-spherical surface (toward the center of the arrangement of magnet coils 502), whereas the magnetic field traveling through the second magnet coil 502e may point outward away from the center of the quasi-sphere surface.

One result of having magnetic coils 502d of a first polarity positioned adjacently to alternately biased magnetic coils 502e of a second polarity is that the resultant alternating magnetic field polarity at the quasi-spherical polyhedral surface minimizes the physical gaps between the adjacent magnetic coils 502f, thereby allowing their individual magnetic fields to return through the adjacent magnetic coils, as can be seen in FIG. 5C. Additionally, also seen in FIG. 5C, the resultant magnetic field at the inner surface of the formed quasi-sphere is effectively parallel to said quasi-sphere's inner surface, except near the coil centers, where the vector-magnetic field has components that point toward or away from the center of the sphere, where by symmetry, the vector fields produced by all coils cancels.

The central region of the confinement volume over which the magnetic field cancels depends upon the radial size of the quasi-spherical surface, the spacing between magnet coil centers, the number of coils used, and the spherical distribution of the electric currents in the coils. As a result, a high intensity magnetic field is formed around the confinement volume, wherein a quasi-spherical low-magnetic field intensity region 514 is formed at the center of the confinement volume. The cancellation of the magnetic field 512 at the center of the sphere helps to maintain the high beta plasma, by ensuring the magnetic-energy density of the fusion-plasma core is much lower than its average plasma energy density. This quasi-spherical region of low magnetic field intensity 514 is configured to confine the plasma within the reactor, thus preventing plasma particles from leaking out of the arrangement of magnet coils, and thus the reactor.

As described hereinabove, maintaining high magnetic beta helps to minimize the Bremsstrahlung radiation (specifically synchrotron radiation) produced by magnetized, energetic-plasma particles, thus reducing power loss and increasing the overall power efficiency of the reactor. Additionally, high beta confinement significantly reduces the volume and cost of the magnetic-field infrastructure, while also increasing the rate at which the fusion-particle collisions occur. This is particularly relevant for aneutronic fuel cycles, wherein the output energy losses from synchrotron radiation or other forms of bremsstrahlung radiation power are much more significant, due to the inherently higher atomic number (and thus, atomic weight) of aneutronic fuel particles. Furthermore, achieving high-magnetic beta combined with a sufficiently high, boundary-magnetic-field intensity are critical requirements for a fusion reactor, in order to minimize energy losses and suitably confine high energy particles during reactor operation.

As described herein, the disclosed plasma confinement apparats of FIG. 4A-5D are configured to be scalable, utilize either neutronic or aneutronic fuel cycles (based on the configuration and operating parameters), while providing classically predicable particle confinement in high magnetic beta and at the corresponding operation temperature. The scalability of the disclosed reactors may be attributed in part to said reactor's ability to suitably confine fuel particles at reactor sizes that are far more compact and manageable than those currently utilized effectively in the art. Modification of the size (e.g., the radius quasi-sphere) may result in proportional modification of the power output from the corresponding plasma confinement apparatus. To be more precise the output power, Pₒᵤₜ, for said plasma confinement apparatus is proportional to the cube of the radius of the quasi-sphere, r (e.g., Pₒᵤₜ∝r³).

When the individual particle energies comprising a fusion plasma follow trajectories that are comparable to the size of the confinement vessel and the spacings between magnet coils, the transport behavior for the aggregate assembly will be governed by physics equations with well described classical solutions. This contrasts with non-classical transport behavior in confinement systems where the size of the individual particle trajectory orbits are much smaller than the dimensions of the confinement vessel. Non-classical behavior is analogously referred to as anomalous, due to the need for heuristic assumptions and similar arguments applied to various transport descriptions. The physical basis for classical behavior is because energetic particles can follow a predictable trajectory while averaging a multitude of small-scale fluctuations present in the plasma that are the cause of anomalous transport. The argument for classical behavior is essentially one of comparative scale lengths. Classical behavior is well verified in a multitude of experimental plasma implementations, computations, and theory and is expected in an aneutronic fusion plasmas characterized by a ten-fold higher particle energies and temperatures than found in neutronic fusion plasmas.

As described hereinabove, the scalability of the disclosed arrangement of magnet coils 502 allows for the radius of the quasi-sphere surface to be adjusted to achieve a certain power output using a specific, selected fuel cycle and further allows the same type of reactor using the same type of fuel to be utilized in various applications, wherein the size of the reactor is merely scaled to fit the application's power needs. For example, a first smaller reactor having a smaller quasi-sphere radius may utilize an aneutronic fuel cycle to suitably provide power to a truck or vehicle requiring several MWs of power to operate, while a second larger reactor having a larger quasi-sphere radius may utilize the same aneutronic fuel cycle to suitably provide power to a city requiring many GWs of power. The same configuration and type of magnetic coils may be utilized in the two different reactors, wherein the principal physical difference between the two reactors is the size of the quasi-sphere, and thus the quantity and/or scale of the magnet coils used.

The disclosed scalable plasma confinement apparatus is configured to allow for the generation of power from either neutronic or aneutronic fuel cycles within the same type of reactor configuration, through selective implementation or modification of certain components and operating parameters. As disclosed hereinabove, a reactor configured to harness an aneutronic reaction may utilize higher strength magnetic field (on the scale of several tens of Tesla), NIBS for energetic particle beam injectors, and DECs and photonic converters for energy converters. Conversely, the same reactor being configured for harnessing the power of a neutronic reaction may simply require adjustment of the magnetic field strength for arrangement of magnet coils 502 and particle velocity from the NIBS (or usage of the well know NBIs) to suitably accommodate and maintain the reaction while suitably confining energetic plasma particles within the arrangement of magnetic coils 502.

Similarly to the plasma confinement apparatus of FIG. 4A-4E, the herein disclosed plasma confinement apparatus of FIG. 5A-5D is configured to provide a scalable infrastructure that provides magnetic confinement capabilities that enable the utilization and confinement of the higher energy particles needed for aneutronic fusion. As can be seen in FIG. 5C, the quasi-spherical arrangement of magnetic coils 502 results in the magnetic field 512 forming a region of low-magnetic field intensity 514 around the core plasma of the disclosed plasma confinement apparatus. The confinement efficacy of this disclosed reactor configuration is demonstrated in FIG. 5D, wherein particle trajectory simulations for corresponding quasi-spherical polyhedron of magnet coils 502 are displayed. In said simulation, six independent hydrogen-ion particles are launched at zero time from the center of the polyhedron: one in each opposite direction along each coordinate axis, ±x, ±y, ±z. The operating conditions for this simulation are a magnetic-field intensity of, |B|≡B˜25 Tesla, and ion-particle velocity of, vᵢ≅7×10⁶ m/s. Said configuration provides excellent particle confinement for these higher conditions (velocity and field intensity), as evidenced by the ion particle remaining confined within the observed timespan. As such, this concept is suitable for both neutronic and aneutronic fusion reactions.

As should be expected, depending on the particular fuel cycle utilized, the magnetic-field intensity may need to be appropriately adjusted to achieve efficient fuel-particle confinement. For neutronic fuels the magnetic B field intensity may be of order of several Tesla, such as 5 Tesla, for example, while for aneutronic fuels the magnetic B field intensity may need to be of order of several tens of Tesla, such as 25 Tesla, for example. As aneutronic-fusion fuels are characterized by much larger mass and atomic number relative to that for D—D fusion, D—T fusion or other neutronic fusion cycles, their threshold reaction temperature or ignition temperature is also much higher, of the order of 500 keV and more. In the particle simulation for the quasi-spherical polyhedron in FIG. 5D, the higher particle energy and magnetic-field intensity were used to specifically demonstrate that this concept is suitable for aneutronic nuclear fusion, in addition to also be suitable for the less stringent requirements for neutronic nuclear fusion.

The superior confinement capabilities of the disclosed quasi-spherical arrangement of magnetic coils 402, 502 allows the same type of scalable fusion reactor to provide classically predicted confinement in a high-beta, spherical configuration, regardless of the type of fuel cycle (neutronic or aneutronic). For example, in a spherical geometry, compared to other reactor geometrics, it is easier to manufacture a multitude of smaller magnetic coils 502d, 502e, such as superconducting coil magnets, having smaller dimensions (e.g., a magnet coil arrangement having a 0.5-1 m diameter, or similar dimension), thus enabling a much higher magnetic field intensity to be produced. As noted, this higher magnetic field intensity enables the confinement particles of higher energies than those typically used in neutronic-based fusion, wherein the coil sizes for typical fusion reactors are of the order of several meters transverse dimensions. Additionally, while not addressed in depth herein, the spherical geometry is suitably adapted to maintain the stability of the magnetically confined plasma, a factor that is a consistent concern within toroidal and cylindrical geometries. Additionally, spherical geometries are estimated to be capable of achieving extremely small and compact sizes when compared to other shapes of reactor, as discussed hereinbelow, while still maintaining suitable operating conditions, such as magnetic field intensity, to allow for proper, classical particle confinement, thus allowing for the scale and power output of a reactor utilizing said spherical geometry to be varied significantly depending on the needs of the application.

One well known aneutronic fusion reaction is the fusion reaction of a proton with Boron 11. The power density in a p-B¹¹ reaction is estimated from, P/V=n₁n₂<σv>Eₒᵤₜ, where n₁, n₂≅10¹⁵ cm⁻³ are typical fuel densities, <σv>≅4×10⁻¹⁶ cm3/s is the reactivity, and Eₒᵤₜ≅8.7 MeV; with the result, P/V≅600 W/cm3. As stated and articulated hereinabove, a reactor's output power is dependent upon the reaction volume for said reactor. Thus, for reactors configured to utilize this p-B¹¹ reaction, a spherical reactor configured to deliver an output power of 1 MW would be estimated to have a radius of approximately 7 cm, while a toroidal reactor, such as a field-reversed configuration reactor (“FRC”), with the same 1 MW output power would require a radius of 150 cm, a length of 0.5 cm and a radial width of 3 cm, and a cylindrically based “mirror” configuration with a 1 MW output power would require a radius of 50 cm and a length of 20 cm. In general, the geometry of a sphere/quasi-sphere allows it to provide a greater volume while maintaining an overall compact size with a small surface area, when compared to other geometries that may require a certain length, radius or radial width in order to operate nominally as a reactor.

In addition to providing superior, classical confinement of the particles, the disclosed arrangement of magnetic coils 502 may be configured to guide energetic products out of the quasi-spherical polyhedral surface and directly into the DECs, such as DEC 305 of FIG. 3, by biasing the magnet coils 502d, 502e appropriately, for example, by varying the magnetic coil 502d, 502e currents locally to alter the magnetic-field intensity and thereby direct the charged particles into energy converters. This procedure may facilitate the efficient capture of the particle energy, thus increasing the overall recovery efficiency of the reactor.

Both of the disclosed configurations of the arrangements of magnet coils 402, 502 may be utilized within a reactor setup in order to provide enhanced particle confinement capable of confining the high energy particles required for aneutronic fusion, as well as the less energetic particles used in neutronic fusion. This being said, the particular coil arrangement utilized in the disdyakis dodecahedron arrangement of magnet coils 502 seen in FIG. 5A allows for individual magnet coils to be positioned at angles that are not simply tangential to the surface of the quasi-spherical polyhedron. This non-tangential arrangement of magnet coils 502d, 502e may improve the effective shielding of the centers of each magnet coil from a direct line-of-sight to the center of the configuration. This in turn may enhance particle confinement capabilities of this disdyakis dodecahedron arrangement of magnet coils 502, as a result of there not being a direct line-of-sight out of the reactor along a single magnetic field line for particles to follow.

FIG. 6A illustrates plasma propagation into a transverse magnetic B field, according to an aspect. FIG. 6B-6D illustrates neutralized, intense ion beams 640 of various energy and polarity conditions propagating through the transverse magnetic B field, according to an aspect. FIG. 6E illustrates the current of a repetitively pulsed neutralized ion beam over time, according to an aspect. A NIB 640 will penetrate a transverse-magnetic field, propagating across it undeflected by several mechanisms, depending on the energy density of the beam relative to that of the transverse B field. FIG. 6A characterizes the direction of beam propagation relative to the orientation and gradient of the magnetic B field. FIG. 6B characterizes the beam propagation mechanism for a lower energy density beam 640a, when the beam-energy density is low and the electrons and ions penetrate as either particles characterized by their individual gyroradii, or a modified-hybrid depth when the beam-energy density is sufficient for space-charge effects to alter the motion of the individual particles, allowing the beam to penetrate to a depth equal to the hybrid-gyroradius.

In the beam propagation mechanism of FIG. 6C, the low beta, polarized beam 640b deposits charged particles to the plasma core incrementally. FIG. 6E displays the time profile for a repetitively pulsed, NIB, where the energy-deposition rate is determined by the magnitude of the beam current, ΔI 650, the pulse duration, τₚ 651, and the pulse-repetition frequency, τᵣᵣ 652. The time average of the injected current pulses maintains a steady-state current level of, I₀ 653.

A final beam propagation mechanism is illustrated in FIG. 6D. In this mode the beam energy density of beam 640c is much larger than that of the magnetic field. Thus, the beam penetrates by excluding the magnetic field due to self-consistent, diamagnetic currents that are sustained on the beam surface, effectively preventing the transverse field from penetrating into the beam interior on the timescale that the beam propagates across the field. If the beam energy density remains sufficiently high as the beam traverses the magnetic field, it's possible that it may not be confined, thus exiting the magnetic field on the other side of the system.

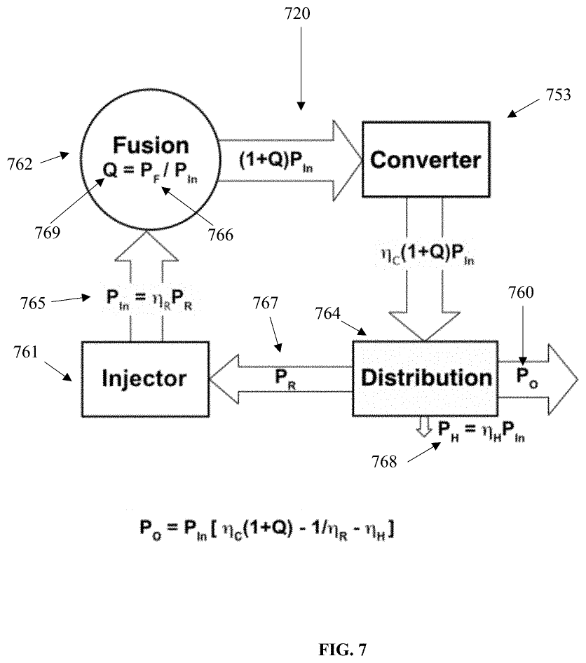

FIG. 7 illustrates a simplified power balance diagram 720 for the disclosed reactor, according to an aspect. Analyzing the circulating power cycle in a hypothetical reactor provides a reality check on the “break-even” energy gain needed to supply an output power 760, P₀=0, to a load. The simplified diagram of FIG. 7 illustrates the essential power-cycle components, including an injector 761, a reactor portion 762, a converter 763 and a distributer 764, used with the following assumed efficiencies: an overall energy-conversion efficiency, η_{C}, of 0.85, a recycled-energy efficiency, η_{R}, of 0.6, and a “household-use” energy efficiency, η_{H} of 0.01. The various power values associated with the above components include: an input power, Pᵢₙ 765, emitted from the injector 761, a fusion power, P_{F} 766, based on the fusion reaction utilized, an output or “for sale” power, P₀, 760, released from the reactor system for external use, a recirculating power, P_{R} 767, indicating the power deliver from the distributor 768 to the injector 761, and housekeeping power, P_{H} 768, designated for powering auxiliary operations. The threshold energy gain, Q 769, is estimated as 3, for p-B¹¹ fusion, slightly less than the Q value estimated for p-B¹¹ aneutronic fuel cycle discussed hereinabove. Increasing the power—cycle efficiencies much beyond those disclosed above may be a challenge. Additional enhancements have been identified that can increase the fusion gain, for example by augmenting the input energy source with high-power waves, using spin-polarized fuel nuclei, and muon-catalyzed reactions.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or.

The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Referring to adjacent magnet coils as being “alternately biased” indicates that each magnet coil has an opposite magnetic-field polarity in relation to adjacent magnet coils.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A plasma confinement apparatus comprising:
a vacuum tight container configured to maintain the pressure of confined plasma;
a rhombicosidodecahedron arrangement of magnet coils inside the vacuum tight container that defines a quasi-spherical polyhedral surface;
an arrangement of several neutralized, intense ion beam injectors mounted inside the vacuum tight container and outside the rhombicosidodecahedron arrangement of magnet coils;
an arrangement of direct energy converters mounted inside the vacuum tight container and outside the rhombicosidodecahedron arrangement of magnet coils, said direct energy converters being configured to recover net energy produced by fusion reactions within the confined plasma;
wherein, a low-magnetic field intensity region is formed inside the rhombicosidodecahedron arrangement of magnet coils, said low-magnetic field intensity region being configured to confine plasma within the quasi-spherical polyhedral surface.

2. The plasma confinement apparatus of claim 1, wherein adjacent magnet coils of the rhombicosidodecahedron arrangement of magnet coils are alternately biased.

3. The plasma confinement apparatus of claim 1, wherein an output energy of the disclosed plasma confinement apparatus is scalable and proportional to the cubed value of the radius of said quasi-spherical polyhedral surface.

4. The plasma confinement apparatus of claim 1, further comprising a plurality of photonic converters mounted inside the vacuum tight container, said plurality of photonic converters being configured to collect synchrotron radiation energy.

5. A plasma confinement apparatus comprising:
an arrangement of magnet coils that define a quasi-spherical polyhedral surface;
an arrangement of energetic particle beam injectors mounted outside the arrangement of magnet coils;
an arrangement of energy converters mounted outside the arrangement of magnet coils, said energy converters being configured to recover net energy produced by fusion reactions between confined plasma particles;
wherein, a low-magnetic field intensity region is formed inside the arrangement of magnet coils, said low-magnetic field intensity region being configured to confine plasma within the quasi-spherical polyhedral surface.

6. The plasma confinement apparatus of claim 5, wherein adjacent magnet coils of the arrangement of magnet coils are alternately biased. The plasma confinement apparatus of claim 5, wherein each magnet coil of the arrangement of magnet coils is triangular.

8. The plasma confinement apparatus of claim 5, wherein an output energy of the disclosed plasma confinement apparatus is scalable and proportional to the cubed value of the radius of said quasi-spherical polyhedral surface.

9. The plasma confinement apparatus of claim 5, wherein the confined plasma particles are inherently high-magnetic beta.

10. The plasma confinement apparatus of claim 5, wherein the arrangement of energetic particle beam injectors is comprised of a plurality neutralized, intense ion beams injectors.

11. The plasma confinement apparatus of claim 10, wherein the arrangement of energy converters is comprised of a plurality high efficiency direct energy converters.

12. The plasma confinement apparatus of claim 11, further comprising a plurality of photonic converters mounted inside or outside the arrangement of magnet coils, said plurality of photonic converters being configured to collect synchrotron radiation energy.

13. The plasma confinement apparatus of claim 5, wherein the plasma confinement apparatus is configured to confine plasma particle during neutronic or aneutronic reactions.

14. A plasma confinement apparatus comprising:
an arrangement of magnet coils that define a quasi-spherical polyhedral surface,
wherein adjacent magnet coils within the arrangement of magnet coils are alternately biased;
wherein a low-magnetic field intensity region is formed inside the arrangement of magnet coils, said low-magnetic field intensity region being configured to confine plasma within the quasi-spherical polyhedral surface.

15. The plasma confinement apparatus of claim 14, wherein each magnet coil of the arrangement of magnet coils is a triangle.

16. The plasma confinement apparatus of claim 14, wherein each magnet coil of the arrangement of magnet coils is a triangle, square or pentagon.

17. The plasma confinement apparatus of claim 14, wherein the arrangement of magnet coils is comprised of both structural magnet coils and virtual magnet coils.

18. The plasma confinement apparatus of claim 14, wherein an output energy of the disclosed plasma confinement apparatus is scalable and proportional to the cubed value of the radius of said quasi-spherical polyhedral surface.

19. The plasma confinement apparatus of claim 14, wherein the plasma confinement apparatus is configured to confine plasma during neutronic or aneutronic reactions.

20. The plasma confinement apparatus of claim 14, wherein electrical current is shared by adjacent magnet coils within the arrangement of magnet coils.
